(19) United States
(12) Patent Application Publication
(10) Pub. No.: US 2017/0107445 A1
(43) Pub. Date: Apr. 20, 2017

(54) METHOD FOR RECOVERING LIPIDS BY MEANS OF A BEAD MILL

(71) Applicants: ALGOSOURCE, SAINT NAZAIRE (FR); UNIVERSITE DE NANTES, NANTES (FR)

(72) Inventors: Sébastien JUBEAU, Guerande (FR); Valéria MONTALESCOT, Guerande (FR); Thomas RINALDI, Pornichet (FR); Sergio RIOS, Pornichet (FR); Luc MARECHAL, Saint Nazaire (FR); Jérémy PRUVOST, Saint Brevin Les Pins (FR)

(73) Assignees: ALGOSOURCE, SAINT NAZAIRE (FR); UNIVERSITE DE NANTES, NANTES (FR)

(21) Appl. No.: 15/295,651

(22) Filed: Oct. 17, 2016

(30) Foreign Application Priority Data
Oct. 16, 2015 (FR) 1559840

(51) Int. Cl. C11B 1/02; C11B 1/10

(52) U.S. Cl. CPC C11B 1/02; C11B 1/10

(57) ABSTRACT

The method for treating a microalgal biomass, characterized in the following steps: having a microalgal biomass comprising at least 15% by weight of lipids relative to the total weight of the biomass and having a dry matter concentration of between 1 g/l and 200 g/l, milling said biomass by a bead mill, operated under the following conditions: the mean diameter of the beads (d_{GM}) ranges from 0.2 to 2.5×10⁻³ m, preferably from 0.4 to 1.0×10⁻³ m and is preferably approximately 0.6×10⁻³ m, the blade-tip agitation speed (υ) ranges from 4 to 50 m·s⁻¹, preferably from 5 to 20 m·s⁻¹ and is preferably approximately 8 m·sec⁻¹; recovering the composition obtained.

The present invention relates to the field of the exploitation of algal biomass; more specifically, the present invention relates to a method for extracting lipids derived from microalgae.

Microalgae are eukaryotic organisms which are mainly unicellular, and are delimited by a plasma membrane and a cell wall. The composition and the structure of this cell wall may vary depending on the microalga in question.

Thus, in some green microalgae such as Chlorella, it consists of cellulose and has a high degree of rigidity, leading to an increased resistance of the alga to mechanical stresses.

For the microalgae belonging to the class of the diatoms, the cell wall, also referred to as frustule, consists of crystallized silica. The latter is more brittle than that of Chlorella.

Finally, other species deposit a polysaccharide sheath around their cell in order to protect themselves from environmental attacks. The thickness of this sheath varies over time; it is quite thin during exponential growth of the microalga, then thicker in the stationary phase.

The interest in exploiting microalgae is growing; thus, microalgae have numerous applications, in particular in food, cosmetic products, pharmaceutical products, etc. In addition, much research is being carried out into algal biomass, with a view to using it as biofuel.

With the purpose of exploiting all the microalgal biomass, with a view to biorefining, it is necessary to fractionate and isolate the different metabolites of said microalga.

The main metabolites of microalgae, namely polysaccharides, proteins and pigments, are generally soluble in the culture medium. Moreover, the microalgae may, under certain conditions, accumulate large amounts of lipids in the form of globules of triglycerides referred to as “TAGs” (fatty acid triglycerides). In addition, they also produce polyunsaturated fatty acids, referred to as “PUFAs”, in the form of phospholipids and glycolipids having a high added value.

The aim of the present invention is specifically the recovery of lipids from the algal biomass and more specifically fatty acid triglycerides and polyunsaturated fatty acids.

These two fractions are conventionally recovered via extraction, by organic solvent, on a biomass dried beforehand, then by fractionation of the different classes of lipids via various unitary operations (selective extraction, selective precipitation, distillation, etc.). Lipids are thus recovered in the organic phase and the proteins in the fraction which is insoluble in said organic solvent. This technology is especially described in: “Lipid extracted algae as a source for protein and reduced sugar: a step closer to the biorefinery.” Ansari, F. A., A. Shriwastav, S. K. Gupta, I. Rawat, A. Guldhe and F. Bux (2015) Bioresour Technol 179: 559-564.

This method involves high energy consumption linked to the drying of the biomass, which also causes degradation of certain heat-sensitive compounds such as vitamins, pigments or certain proteins. The series of operations and also the large amounts of solvent involved make the process complex and increase production costs.

One of the main advantages of the method according to the invention is that it may be carried out on a biomass without the latter being dried beforehand. The method according to the invention thus makes it possible to avoid carrying out a drying step which is long and costly both in terms of energy and money.

US2013/0338384 discloses a method for recovering lipids from a microalgal biomass, comprising the heating of said biomass to a temperature ranging from 80° C. to 150° C. at a pressure ranging from 1 to 5 bar.

Methods for disintegrating Chlorella vulgaris cells with a view to recovering lipids suitable for biodiesel production are also especially described in the publication “Disruption of Chlorella vulgaris Cells for the Release of Biodiesel-Producing Lipids: A Comparison of Grinding, Ultrasonication, Bead Milling, Enzymatic Lysis, and Microwaves”, Hongli Zheng et al., Appl. Biochem Biotechnol (2011) 164:1215-1224.

This publication does not describe the conditions of the method according to the invention, which uses a bead mill and which makes it possible to obtain a composition which may then be readily exploited by simple centrifugation.

The technical problem posed which is the basis of the present application was to make available a method for fractionating lipids contained in a microalgal biomass which does not necessitate drying said biomass, which makes it possible to dispense with the use of solvents and which leads to obtaining a composition, the different constituents of which may subsequently be readily separated.

Indeed, within the framework of biorefining biomass, selective extraction of each of the constituents is sought.

The method according to the invention responds to these demands.

A first subject of the present invention targets a method for treating a microalgal biomass, comprising the following steps:
having a microalgal biomass comprising at least 15% by weight of lipids relative to the total weight of said biomass and having a dry matter concentration of between 1 g/l and 200 g/l,
milling said biomass by means of a bead mill, operated under the following conditions:
   the mean diameter of the beads (d_{GM}) ranges from 0.2 to 2.5×10⁻³ m, preferably from 0.4 to 1.0×10⁻³ m and is preferably approximately 0.6×10⁻³ m,
   the blade-tip agitation speed (υ) ranges from 4 to 50 m·s⁻¹, preferably from 5 to 20 m·s⁻¹ and is preferably approximately 8 m·sec⁻¹;
   recovering the composition obtained.

The conditions for carrying out the milling according to the invention make it possible to ensure the release of virtually all the droplets of triglycerides, while ensuring partial deconstruction of the cell structures leading to the release of some, or even all, the phospholipids and glycolipids.

In addition, the conditions for carrying out the milling according to the invention make it possible to avoid too great a homogenization of the medium, and consequently to avoid the formation of an emulsion.

The composition obtained at the end of the milling has the advantage of being subsequently readily exploitable.

A second subject of the invention targets the composition liable to be by the method according to the invention.

The step of using a bead mill according to the invention is advantageously followed by the following steps, in this order:
a step of centrifugation at a centrifuge acceleration of between 3500 g and 20 000 g for a duration of between 2 and 40 minutes, at a temperature of between 5 and 40° C. of the composition obtained, said centrifugation step leading to the production of at least 3 phases;
a step of recovery of the phases making it possible to isolate a first phase referred to as “superpellet”, a second phase referred to as “supernatant”, denser than the first phase, and a third phase referred to as “pellet”, denser than the second phase.

Advantageously, the step of centrifugation is carried out directly on the composition obtained at the end of the step using a bead mill, that is to say that the step of centrifugation is carried out after the step using a bead mill without intermediate step(s) other than the step targeting the recovery of said composition obtained.

The method according to the invention therefore makes it possible to fractionate the lipids and the proteins contained in microalgae without drying the biomass (wet extraction) or using solvents, thereby avoiding denaturing the compounds while limiting the volumes to be treated.

Another advantage of the method according to the invention is that it may be carried out directly on the culture medium, in particular on a suspension of microalgae leaving production, which contributes to reducing the volumes of water used to carry out said method.

Thus, the method according to the invention makes it possible to work with a concentrated biomass harvested directly after culturing.

Advantageously, by carrying out only two steps: a step of milling and a step of phase separation, it is possible to directly obtain three phases selectively enriched in different compounds: a lipid-rich first phase referred to as “superpellet”, a protein-rich second phase referred to as “supernatant”, and a third phase referred to as “pellet”, rich in insoluble compounds.

The superpellet and the pellet may thus be directly exploitable and the supernatant may be subjected to a membrane filtration operation enabling either the separation of the dissolved sugars and proteins from the TAGs or the concentration of the proteins and the TAGs to give two purified fractions.

In this case, no adverse effects on the molecules linked to drying the biomass and using solvent are observed.

Microalgal Biomass

The method according to the present invention is carried out starting from a sufficiently lipid-rich and sufficiently concentrated microalgal biomass; thus, the microalgal biomass comprises at least 15%, preferably approximately 17.5% by weight of lipids, relative to the total weight of the biomass; in addition, the microalgal biomass has a dry matter concentration of between 1 g/l and 200 g/l, preferably between 5 g/l and 150 g/l and even more preferably between 35 g/l and 100 g/l, that is to say relative to the volume of the microalgal biomass to be treated.

The microalgal biomass preferably comprises at least one microalga chosen from Nannochloropsis sp., Nannochloropsis oceanica, Nannochloropsis oculata, Tetraselmis suecica, Porphyridium cruentum, Parachlorella kessleri, Dunaliella salina, Chlorella vulgaris, Neochloris oleoabundans, Haematococcus pluvialis and preferably from the following strains; Nannochloropsis oceanica, Parachlorella kessleri, Tetraselmis suecica.

Method Using a Bead Mill

The method according to the invention comprises a step during which a bead mill is used.

Bead mills are conventionally used for the homogenization of viscous products such as paints, and also for milling minerals. Bead mills comprise a chamber, for example a bowl covered with a lid, intended to receive the composition to be treated, said chamber being supplied via a pump with the composition to be treated.

Conventionally, the filling content of beads in the mill, corresponding to the percentage of the volume of the bowl occupied by the beads, ranges from 50% to 80%, preferably from 70% to 80% volume/volume, and advantageously approximately 75% volume/volume.

The content of the chamber, aside from beads, essentially comprises the microalgal biomass.

The filling content may be adapted, especially as a function of the nature of the beads used. This is because in certain cases an agglomeration of the beads between the blades of the agitator has been able to be observed.

It is part of the knowledge of those skilled in the art to select the filling content suited to the medium to be treated.

The flow rate of supply of the composition into the mill generally ranges from 150 ml/min to 200 ml/min. It is also part of the knowledge of those skilled in the art to select the supply flow rate suited to the medium to be treated.

The treatment in a bead mill is preferably carried out for a duration (residence time) ranging from 1 to 30 minutes, preferably from 2 to 20 minutes, even more preferably from 4 to 10 minutes and advantageously for approximately 6 minutes.

The treatment in the bead mill is generally carried out at a temperature, generally regulated, ranging from 18° C. to 40° C., preferably ranging from 18° C. to 25° C.

As already mentioned, the mechanical treatment method according to the invention uses a bead mill, preferably with glass beads, under the following conditions:
the mean diameter of the beads (d_{GM}) ranges from 0.2 to 2.5×10⁻³ m, preferably from 0.4 to 1.0×10⁻³ m and is preferably approximately 0.6×10⁻³ m,
the blade-tip agitation speed (υ) ranges from 4 to 50 m·s⁻¹, preferably from 5 to 20 m·s⁻¹ and is preferably approximately 8 m·sec⁻¹;

At the end of the bead-milling step, the composition obtained is advantageously recovered.

According to one embodiment of the method, a single bead-milling step is carried out.

According to a preferred embodiment of the method, the treatment in a bead mill is repeated at least twice, preferably between two and ten times and advantageously between three and four times.

This method is preferably carried out batchwise in order to be able to simply treat a volume of biomass.

Centrifugation Step

As already mentioned, the operating conditions enabling centrifugation which gives the three stated phases are:
a centrifuge acceleration of between 3500 g and 20 000 g, preferably between 6000 g and 15 000 g and even more preferably of approximately 12 000 g,
for a duration of between 2 and 40 minutes, preferably between 5 and 30 minutes and even more preferably between 10 and 20 minutes,
at a temperature of between 5 and 40° C., preferably between 10 and 30° C. and even more preferably between 20 and 25° C. of the composition obtained.

As already mentioned, at the end of the centrifugation step essentially three phases are obtained, these three phases being selectively enriched in different compounds.

The first phase, the superpellet, generally comprises more than 30%, preferably more than 60% lipids; it also comprises proteins in a limited amount of between 10 and 30%, enabling direct exploitation of the superpellet.

Nonetheless, depending on the intended uses, an operation for separating the proteins present in the superpellet may be carried out.

It is part of the knowledge of those skilled in the art to choose the separation method to be used.

In addition, operations for purification of the superpellet are made easier because of the reduced proportion of proteins.

The first phase essentially comprises a mixture of triglycerides (TAGs) and polyunsaturated fatty acids, referred to as “PUFAs”, in the form of phospholipids and glycolipids.

The second phase, the supernatant, generally comprises more than 20%, preferably more than 40% proteins and also a large amount of lipids.

Consequently, the supernatant may be subjected to one or more operation(s) for separating the proteins and the lipids, especially the TAGs, to obtain two purified fractions; this/these separation operation(s) may advantageously be carried out by means of a membrane.

Advantageously, at least one step of separation of the lipids is carried out on the second phase.

The lipids, especially TAGs isolated at the end of the separation operation(s), and the superpellet, or even the lipids isolated from the superpellet, are advantageously brought together.

The third phase, the pellet, is rich in insoluble compounds. The pellet may be directly exploitable.

The operations for purification of the components are made easier, especially due to the fact that the three phases are selectively enriched in different compounds.

The method according to the invention should be considered to enable targeted and virtually total recovery of the lipids.

Properties of the Lipids

The lipids are used in chemical, cosmetic or pharmaceutical compositions, in the nutraceutical industry, and in food, especially animal feed.

The following examples illustrate the invention without limiting the scope thereof.

### EXAMPLES

For all these examples, a biomass of Nannochloropsis oceanica is used. This biomass was cultured in a 10 l tubular photobioreactor.

The biomass was treated by means of a bead mill (DynoMill Mutlilab, WAB, Switzerland) with glass beads under the conditions specified in each example.

The lipids are assayed by the Folch method.

The proteins are analyzed by absorbance at 280 nm, with this analysis optionally being supplemented by a protein assay carried out according to the BCA protocol, in order to verify the correctness of the spectrophotometric analyses.

### Example 1 (in Accordance with the Invention)

Milling Step
Nannochloropsis oceanica biomass containing 17.5% lipids,
Dry matter concentration of the supply: 75 g/l,
Glass beads 0.6 mm in diameter,
Agitation speed of 8 m·s⁻¹,
φ: Filling content of mill: 75%,
Q: supply flow rate in ml/min: 200,
Temperature regulated to 20° C.,
Mean residence time of 6 minutes.

Centrifugation Step:
Centrifugation in 500 ml containers for 10 minutes at 20° C. and 17 000 g.

| | % by weight relative | % by weight relative |
|---|---|---|
| | to weight of starting | to weight of starting |
| | proteins | TAGs |
| Superpellet | 11 | 42 |
| Supernatant | 48 | 28 |
| Pellet | 40 | 24 |
| Total | 99 | 94 |

In this example, the three fractions mentioned above are indeed recovered.

### Example 2 (Comparative)

Nannochloropsis oceanica biomass containing 12.5% lipids,
Dry matter concentration of the supply: 75 g/l,
Glass beads 0.6 mm in diameter,
Agitation speed of 8 m·s⁻¹,
φ: Filling content of mill: 75%,
Q: supply flow rate in ml/min: 200,
Temperature regulated to 20° C.,
Mean residence time of 6 minutes.

In this example, with a less lipid-rich biomass, only two phases are obtained after centrifugation.

It is therefore possible, via the described invention and in only two operations, to achieve extraction of almost 70% of the total lipids without solvent on a wet biomass, and also fractionation of the TAGs and the PUFA-rich polar lipids.

The superpellet and the pellet may thus be directly exploitable and the supernatant may be subjected to an operation for the separation of the proteins and the TAGs (membranes) leading to two purified fractions.

1. Method for treating a microalgal biomass comprises the following steps:
having a microalgal biomass comprising at least 15% by weight of lipids relative to the total weight of said biomass and having a dry matter concentration of between 1 g/l and 200 g/l,
milling said biomass by means of a bead mill, operated under the following conditions:
the mean diameter of the beads (d_{GM}) ranges from 0.2 to 2.5×10⁻³ m
the blade-tip agitation speed (υ) ranges from 4 to 50 m·s⁻¹;
the filling content of beads in the mill ranges from 50% to 80%
recovering the composition obtained.

2. Method according to claim 1, the treatment in a bead mill being carried out for a duration ranging from 1 to 30 minutes.

3. Method according to claim 1, the filling content of beads in the mill ranging from 70% to 80% volume/volume, and advantageously approximately 75% volume/volume.

4. Method according to claim 1 wherein the step of treatment in a bead mill is followed by the following steps, in this order:
a step of centrifugation at a centrifuge acceleration of between 3500 g and 20,000 g for a duration of between 2 and 40 minutes, at a temperature of between 5 and 40° C. of the composition obtained, said centrifugation step leading to the production of at least 3 phases;
a step of recovery of the phases making it possible to isolate a first phase referred to as “superpellet”, a second phase referred to as “supernatant”, denser than the first phase, and a third phase referred to as “pellet”, denser than the second phase.

5. Method according to, claim 4 wherein at least one step of separation of the lipids is carried out on the second phase.

6. Method according to, claim 1 wherein the microalgal biomass comprises at least one microalga chosen from Nannochloropsis sp., Nannochloropsis oceanica, Nannochloropsis oculata, Tetraselmis suecica, Porphyridium cruentum, Parachlorella kessleri, Dunaliella salina, Chlorella vulgaris, Neochloris oleoabundans, Haematococcus pluvialis.

7. Composition able to be obtained by the method according to claim 1.
